(19) United States
(12) Patent Application Publication
(10) Pub. No.: US 2021/0010898 A1
(43) Pub. Date: Jan. 14, 2021

(54) INTEGRATED STRAIN GAUGE FOR TRACKING MEMBRANE DEFLECTION ON LIQUID LENS

(71) Applicant: CORNING INCORPORATED, CORNING, NY (US)

(72) Inventor: Christian Daniel Gutleben, Ventura, CA (US)

(21) Appl. No.: 16/923,863

(22) Filed: Jul. 8, 2020

Related U.S. Application Data
(60) Provisional application No. 62/872,894, filed on Jul. 11, 2019.

(51) Int. Cl. G01M 11/02; G01L 1/22; G01L 27/00; G02B 3/12

(52) U.S. Cl. CPC G01M 11/0207; G01L 1/2262; G02B 3/12; G01L 27/002; G01L 1/2281

(57) ABSTRACT

A liquid lens apparatus includes a substrate and a temperature compensator. The substrate includes central and peripheral portions and a detector to measure a deflection of the central portion. The temperature compensator is disposed in the peripheral portion to compensate for a temperature dependence of the detector.

### CROSS-REFERENCE TO RELATED APPLICATIONS

This application claims the benefit of priority under 35 U.S.C. § 119 of U.S.

Provisional Application No. 62/872,894, filed Jul. 11, 2019, the content of which is incorporated herein by reference in its entirety.

### FIELD

The present disclosure relates to liquid lens apparatuses and systems, for example, transmissive expandable liquid lens apparatuses and systems.

### BACKGROUND

Liquid lenses generally include two immiscible liquids disposed within a cavity. Varying an electric field to which the liquids are subjected can vary the wettability of one of the liquids with respect to the cavity wall, thereby varying the shape of the meniscus formed between the two liquids. As liquid lenses are subjected to varying temperatures, the liquids can expand and force windows of the liquid lens to deflect. As a consequence, the optical focal length or diopter of the liquid lens shifts.

Accordingly, there is a need for a strain sensor that can be integrated into a liquid lens window and provide feedback regarding the window's deflection, and a temperature sensor that can compensate for a temperature dependence of the strain sensor.

### SUMMARY

In some embodiments, a liquid lens apparatus includes a substrate and a temperature compensator. The substrate includes central and peripheral portions. The central portion includes a detector to measure a deflection of the central portion. The temperature compensator can be disposed in the peripheral portion to compensate for a temperature dependence of the detector.

In some embodiments, the central portion of the substrate includes first and second sections. In some embodiments, the detector includes a resistor disposed radially along the first section between the peripheral portion and the second section. In some embodiments, the detector includes a resistor disposed azimuthally between the first and second sections.

In some embodiments, the temperature compensator includes a resistor disposed azimuthally along the peripheral portion. In some embodiments, the detector can be a strain gauge. In some embodiments, the strain gauge and the temperature compensator include the same material. In some embodiments, the strain gauge and the temperature compensator include doped polysilicon. In some embodiments, the detector and the temperature compensator include substantially a same thickness, width, and length.

In some embodiments, the central portion can include a window, the central portion of the substrate can include first and second sections on an exterior side of the window, and the detector can be disposed on the first section. In some embodiments, the central portion can include a window, the central portion of the substrate can include first and second sections on an interior side of the window, and the detector can be disposed on the first section. In some embodiments, the temperature compensator surrounds a majority of the detector.

In some embodiments, a liquid lens system includes a liquid lens apparatus, a first balancing resistor, a second balancing resistor, and a Wheatstone bridge. The liquid lens apparatus includes a substrate. The substrate includes a window, a peripheral portion, a strain gauge, and a temperature compensator. The strain gauge can be configured to measure a deflection of the window. The temperature compensator can be configured to compensate for a temperature dependence of the strain gauge. The first balancing resistor can be coupled to the strain gauge. The second balancing resistor can be coupled to the temperature compensator. The strain gauge, the temperature compensator, and the first and second balancing resistors can form the Wheatstone bridge.

In some embodiments, the Wheatstone bridge can be configured to directly measure a deflection of the window. In some embodiments, the first and second balancing resistors can have substantially a same resistance. In some embodiments, a sensing voltage between the strain gauge and the temperature compensator of the Wheatstone bridge can be

$$V = {V}_{0} ( \frac{{R}_{e} δ {R}_{s}}{{R}_{0}^{2} + {R}_{e}^{2} + 2 {R}_{0} {R}_{e} + δ {R}_{s} ( {R}_{0} + {R}_{e} )} ) ,$$

wherein V₀ is an applied voltage to the Wheatstone bridge, Rₑ is a resistance of the first and second balancing resistors, R₀ is an unstrained value of the strain gauge and the temperature compensator, and δRₛ is a change in resistance with strain of the strain gauge.

In some embodiments, the strain gauge includes a planar serpentine resistor disposed between the peripheral portion and an inner section of the window. In some embodiments, the strain gauge includes a planar coil resistor disposed along an outer section of the window adjacent an inner section of the window. In some embodiments, the temperature compensator includes a planar coil resistor disposed along the peripheral portion adjacent an outer section of the window.

In some embodiments, a method for measuring a diopter shift in a liquid lens apparatus includes calibrating first and second balancing resistors in a Wheatstone bridge based on unstrained resistance values of a strain gauge and a temperature compensator of the liquid lens apparatus. In some embodiments, the method further includes measuring a diopter shift of the liquid lens apparatus based on strained resistance values of the strain gauge and the temperature compensator and an expansion of a window of the liquid lens apparatus.

In some embodiments, the measuring occurs in real time. In some embodiments, the measuring achieves a sensitivity of at least 0.4 diopter.

Further features and advantages of the disclosure, as well as the structure and operation of various embodiments of the disclosure, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1 is a schematic cross-sectional view of a liquid lens apparatus, according to exemplary embodiments.

FIG. 2 is a schematic top plan view of the liquid lens apparatus of FIG. 1, according to exemplary embodiments.

FIG. 3 is a schematic top plan view of a liquid lens apparatus with integrated radial strain gauge and temperature compensator, according to exemplary embodiments.

FIG. 3A is a schematic cross-sectional view of the liquid lens apparatus of FIG. 3, according to exemplary embodiments.

FIG. 4 is a schematic circuit diagram of a window strain gauge sensor, according to exemplary embodiments.

FIG. 5 is a schematic plot of a strain gauge circuit as a function of diopter shift of the window strain gauge sensor of FIG. 4, according to exemplary embodiments.

FIG. 6 is a schematic top plan view of a liquid lens apparatus with integrated azimuthal strain gauge and temperature compensator, according to exemplary embodiments.

FIG. 6A is a schematic cross-sectional view of the liquid lens apparatus of FIG. 6, according to exemplary embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of this disclosure. The disclosed embodiment(s) are merely exemplary. The scope of the disclosure is not limited to the disclosed embodiment(s), but rather is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper,” and the like, may be used herein for ease of description to describe one element's or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

Exemplary Liquid Lens Apparatus

As discussed above, liquid lenses generally include two immiscible liquids disposed within a cavity disposed between a first window and a second window. Varying an electric field to which the liquids are subjected can vary the wettability of one of the liquids with respect to the cavity wall, thereby varying the shape of the meniscus formed between the two liquids and, thus, changing the optical focal length of the liquid lens.

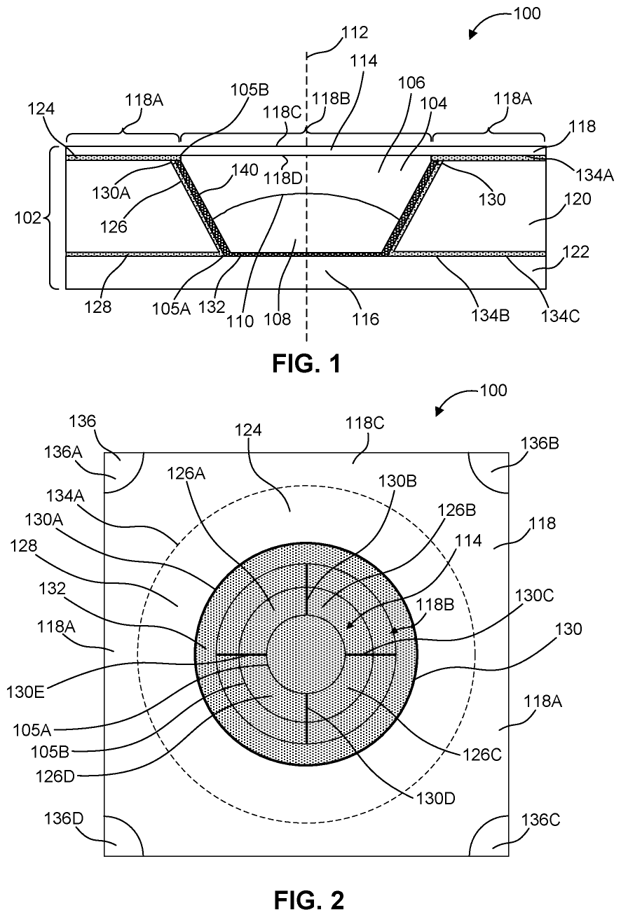

FIG. 1 illustrates a schematic cross-sectional view of liquid lens apparatus 100, according to exemplary embodiments. In some embodiments, liquid lens apparatus 100 can include a lens body 102 and a cavity 104 formed in the lens body 102. A first liquid 106 and a second liquid 108 can be disposed within cavity 104. In some embodiments, first liquid 106 can be a polar liquid or a conducting liquid. Additionally, or alternatively, second liquid 108 can be a non-polar liquid or an insulating liquid. In some embodiments, first liquid 106 and second liquid 108 have different refractive indices such that an interface 110 between first liquid 106 and second liquid 108 forms a lens. In some embodiments, first liquid 106 and second liquid 108 have substantially the same density, which can help to avoid changes in the shape of interface 110 as a result of changing the physical orientation of liquid lens apparatus 100 (e.g., as a result of gravitational forces).

In some embodiments, first liquid 106 and second liquid 108 can be in direct contact with each other at interface 110. For example, first liquid 106 and second liquid 108 can be substantially immiscible with each other such that the contact surface between first liquid 106 and second liquid 108 defines interface 110. In some embodiments, first liquid 106 and second liquid 108 can be separated from each other at interface 110. For example, first liquid 106 and second liquid 108 can be separated from each other by a membrane (e.g., a polymeric membrane) that defines interface 110.

In some embodiments, cavity 104 can be defined by a bore in an intermediate layer 120 of liquid lens apparatus 100, as described herein. In some embodiments, at least a portion of first liquid 106 can be disposed in cavity 104. Additionally, or alternatively, second liquid 108 can be disposed within cavity 104. For example, substantially all or a portion of second liquid 108 can be disposed within cavity 104. In some embodiments, the perimeter of interface 110 (e.g., the edge of the interface in contact with the sidewall 140 of the cavity 104) can be disposed within cavity 104.

Interface 110 can be adjusted via electrowetting. Electrowetting is a modification of the wetting properties or wettability (e.g., ability of a liquid to maintain contact with a surface) of a surface with an applied electric field. For example, a voltage can be applied between first liquid 106 and a surface of cavity 104 (e.g., an electrode positioned near the surface of the cavity 104 and insulated from first liquid 106, as described herein) to increase or decrease the wettability of the surface of the cavity 104 with respect to the first liquid 106 and change the shape of interface 110. In some embodiments, adjusting interface 110 changes the shape of the interface, which changes the focal length or focus of liquid lens apparatus 100. For example, such a change of focal length can enable liquid lens apparatus 100 to perform an autofocus function. Additionally, or alternatively, adjusting interface 110 tilts the interface relative to a structural axis 112 of liquid lens apparatus 100 (e.g., to tilt an optical axis of liquid lens apparatus 100 relative to the structural axis of liquid lens apparatus 100). For example, such tilting can enable liquid lens apparatus 100 to perform an optical image stabilization (OIS) function. Adjusting interface 110 can be achieved without physical movement of liquid lens apparatus 100 relative to an image sensor, a fixed lens or lens stack, a housing, or other components of a camera module in which liquid lens apparatus 100 can be incorporated.

In some embodiments, lens body 102 of liquid lens apparatus 100 can include a first window 114 and a second window 116. In some of such embodiments, cavity 104 can be disposed between first window 114 and second window 116. In some embodiments, lens body 102 can include a plurality of layers that cooperatively form the lens body 102. For example, in the embodiments shown in FIG. 1, lens body 102 can include a first outer layer, or first substrate, 118, an intermediate layer, or second substrate, 120, and a second outer layer, or third substrate, 122. In some embodiments, first substrate 118 can be a flexible membrane. First substrate 118 can include a central portion 118B and a peripheral portion 118A. In some embodiments, central portion 118B can coincide with first window 114. First substrate 118 can include an exterior side 118C (e.g., upper surface of lens body 102) and an interior side 118D (e.g., facing first liquid 106). In some embodiments, second substrate 120 can include a bore formed therethrough. For example, second substrate 120 can include cavity 104. First substrate 118 can be bonded to one side (e.g., the object side) of second substrate 120. For example, first substrate 118 (e.g., peripheral portion 118A) can be bonded to second substrate 120 at a bond 134A. Bond 134A can be an adhesive bond, a laser bond (e.g., a laser weld), or another suitable bond capable of maintaining first liquid 106 and second liquid 108 within cavity 104 (e.g., sealing first liquid 106 and second liquid 108 within cavity 104, or hermetically sealing cavity 104). Additionally, or alternatively, third substrate 122 can be bonded to the other side (e.g., the image side) of second substrate 120 (e.g., opposite first substrate 118). For example, third substrate 122 can bonded to second substrate 120 at a bond 134B and/or a bond 134C, each of which can be configured as described herein with respect to bond 134A. In some embodiments, intermediate layer 120 can be disposed between first outer layer 118 and second outer layer 122, the bore in the intermediate layer 120 can be covered on opposing sides by the first outer layer 118 and the second outer layer 122, and at least a portion of cavity 104 can be defined within the bore. Thus, a portion of first outer layer 118 covering cavity 104 serves as first window 114, and a portion of second outer layer 122 covering cavity 104 serves as second window 116.

In some embodiments, cavity 104 can be defined by the bore in intermediate layer 120. In some embodiments, cavity 104 can be tapered as shown in FIG. 1 such that a cross-sectional area of at least a portion of the cavity decreases along structural axis 112 in a direction from the object side (e.g., first substrate 118) toward the image side (e.g., third substrate 122). For example, cavity 104 can include a narrow end 105A and a wide end 105B. The terms “narrow” and “wide” are relative terms, meaning the narrow end is narrower, or has a smaller width or diameter, than the wide end. Such a tapered cavity 104, or a portion thereof can have a substantially truncated conical cross-sectional shape. Additionally, or alternatively, such a tapered cavity 104 can help to maintain alignment of interface 110 between first liquid 106 and second liquid 108 along structural axis 112. In other embodiments, cavity 104 can be tapered such that the cross-sectional area of cavity 104 increases along structural axis 112 in the direction from the object side (e.g., first substrate 118) to the image side (e.g., third substrate 122) or non-tapered such that the cross-sectional area of cavity 104 remains substantially constant along structural axis 112. In some embodiments, cavity 104 can be rotationally symmetrical (e.g., about structural axis 112 of liquid lens apparatus 100).

In some embodiments, image light can enter liquid lens apparatus 100 through first window 114, can be refracted at interface 110 between first liquid 106 and second liquid 108, and can exit liquid lens apparatus 100 through second window 116. In some embodiments, first outer layer 118 and/or second outer layer 122 can include a sufficient transparency to enable passage of the image light. For example, first outer layer 118 and/or second outer layer 122 can include a polymeric, glass, ceramic, glass-ceramic material, or the like. In some embodiments, outer surfaces of first outer layer 118 and/or second outer layer 122 can be substantially planar. Thus, even though liquid lens apparatus 100 can function as a lens (e.g., by refracting image light passing through interface 110), outer surfaces of liquid lens apparatus 100 can be flat as opposed to being curved like the outer surfaces of a fixed lens. Such planar outer surfaces can make integrating liquid lens apparatus 100 into an optical assembly (e.g., a lens stack) less difficult. In other embodiments, outer surfaces of the first outer layer 118 and/or the second outer layer 122 are curved (e.g., concave or convex). Thus, liquid lens apparatus 100 can include an integrated fixed lens. In some embodiments, intermediate layer 120 can include a metallic, polymeric, glass, ceramic, glass-ceramic material, or the like. Because image light can pass through the bore (e.g., cavity 104) in intermediate layer 120, intermediate layer 120 may or may not be transparent.

Although lens body 102 of liquid lens apparatus 100 is described as including first outer layer 118, intermediate layer 120, and second outer layer 122, other embodiments are included in this disclosure. For example, in some other embodiments, one or more of the layers can be omitted. For example, the bore in intermediate layer 120 can be configured as a blind hole that does not extend entirely through intermediate layer 120, and second outer layer 122 can be omitted. In some embodiments, cavity 104 can be disposed within the bore in intermediate layer 120. Thus, a first portion of cavity 104 can be an upper portion of the bore, and a second portion of cavity 104 can be a lower portion of the bore. In some other embodiments, cavity 104 can be disposed partially within the bore in intermediate layer 120 and partially outside the bore.

In some embodiments, liquid lens apparatus 100 can include a common electrode 124 in electrical communication with first liquid 106. Additionally, or alternatively, liquid lens apparatus 100 can include a driving electrode 126 disposed on a sidewall 140 of cavity 104 and insulated from first liquid 106 and second liquid 108. Different voltages can be supplied to common electrode 124 and driving electrode 126 to change the shape of interface 110 as described herein.

In some embodiments, liquid lens apparatus 100 can include a conductive layer 128, at least a portion of which is disposed within cavity 104 and/or defines at least a portion of the sidewall 140 of the cavity 104. For example, conductive layer 128 can include a conductive coating applied to intermediate layer 120 prior to bonding first outer layer 118 and/or second outer layer 122 to intermediate layer 120. Conductive layer 128 can include a metallic material, a conductive polymer material, another suitable conductive material, or a combination thereof. Additionally, or alternatively, conductive layer 128 can include a single layer or a plurality of layers, some or all of which can be conductive. In some embodiments, conductive layer 128 can define common electrode 124 and/or driving electrode 126. For example, conductive layer 128 can be applied to substantially the entire outer surface of intermediate layer 120 prior to bonding first outer layer 118 and/or second outer layer 122 to intermediate layer 120. Following application of conductive layer 128 to intermediate layer 120, conductive layer 128 can be segmented into various conductive elements (e.g., common electrode 124, driving electrode 126, and/or other electrical devices). In some embodiments, liquid lens apparatus 100 can include one or more scribes 130 in conductive layer 128 to isolate (e.g., electrically isolate) common electrode 124 and driving electrode 126 from each other. For example, scribe 130A can be formed by a photolithographic process, a laser process (e.g., laser ablation), or another suitable scribing process. In some embodiments, scribes 130 can include a gap in conductive layer 128. For example, scribe 130A can be a gap with a width of about 5μm, about 10μm, about 15μm, about 20μm, about 25μm, about 30μm, about 35μm, about 40μm, about 45μm, about 50μm, or any ranges defined by the listed values.

Although conductive layer 128 is described in reference to FIG. 1 as being segmented following application to intermediate layer 120, other embodiments are included in this disclosure. For example, in some embodiments, conductive layer 128 can be patterned during application to intermediate layer 120. For example, a mask can be applied to intermediate layer 120 prior to applying conductive layer 128 such that, upon application of conductive layer 128, masked regions of intermediate layer 120 covered by the mask can correspond to the gaps in conductive layer 128, and upon removal of the mask, the gaps are formed in conductive layer 128.

In some embodiments, liquid lens apparatus 100 can include an insulating layer 132 disposed within cavity 104. For example, insulating layer 132 can include an insulating coating applied to intermediate layer 120 prior to bonding first outer layer 118 and/or second outer layer 122 to intermediate layer 120. In some embodiments, insulating layer 132 can include an insulating coating applied to conductive layer 128 and second window 116 after bonding second outer layer 122 to intermediate layer 120 and prior to bonding first outer layer 118 to intermediate layer 120. Thus, insulating layer 132 can cover at least a portion of conductive layer 128 within cavity 104 (e.g., driving electrode 126) and second window 116. In some embodiments, insulating layer 132 can be sufficiently transparent to enable passage of image light through second window 116 as described herein. Insulating layer 132 can include polytetrafluoroethylene (PTFE), parylene, another suitable polymeric or non-polymeric insulating material, or a combination thereof. Additionally, or alternatively, insulating layer 132 can include a hydrophobic material. Additionally, or alternatively, insulating layer 132 can include a single layer or a plurality of layers, some or all of which can be insulating.

In some embodiments, insulating layer 132 can cover at least a portion of driving electrode 126 (e.g., the portion of the driving electrode disposed within cavity 104) to insulate first liquid 106 and second liquid 108 from driving electrode 126. Additionally, or alternatively, at least a portion of common electrode 124 can be disposed within cavity 104 and uncovered by insulating layer 132. Thus, common electrode 124 can be in electrical communication with first liquid 106 as described herein. In some embodiments, insulating layer 132 can include a hydrophobic surface layer in cavity 104. Such a hydrophobic surface layer can help to maintain second liquid 108 within a lower portion of cavity 104 (e.g., by attraction between the non-polar second liquid 108 and the hydrophobic material) and/or enable the perimeter of interface 110 to move along the hydrophobic surface layer (e.g., by electrowetting) to change the shape of the interface 110 as described herein.

FIG. 2 illustrates a schematic top plan view of liquid lens apparatus 100 shown in FIG. 1, looking through first outer layer 118, according to exemplary embodiments. For clarity in FIG. 2, and with some exceptions, bonds (e.g., 134A, 134B, 134C) generally are shown in dashed lines, scribes (e.g., 130, 130A, 130B, 130C, 130D, 130E) generally are shown in heavier lines, and other features generally are shown in lighter lines.

In some embodiments, common electrode 124 is defined between scribe 130A and an outer edge of liquid lens apparatus 100. A portion of common electrode 124 can be uncovered by insulating layer 132 such that common electrode 124 can be in electrical communication with first liquid 106 as described herein. In some embodiments, bond 134A can be configured such that electrical continuity can be maintained between the portion of conductive layer 128 inside the bond (e.g., inside cavity 104 and/or between the bond and scribe 130A) and the portion of conductive layer 128 outside the bond (e.g., outside cavity 104 and/or outside the bond). In some embodiments, liquid lens apparatus 100 can include one or more cutouts 136 in first outer layer 118. For example, as shown in FIG. 2, liquid lens apparatus 100 can include a first cutout 136A, a second cutout 136B, a third cutout 136C, and a fourth cutout 136D. In some embodiments, cutouts 136 can include portions of liquid lens apparatus 100 at which first outer layer 118 is removed to expose conductive layer 128. Thus, cutouts 136 can enable electrical connection to common electrode 124, and the regions of conductive layer 128 exposed at the cutouts can serve as contacts to enable electrical connection of liquid lens apparatus 100 to a controller, a processor, a driver, or another component of a lens or camera system.

Although cutouts 136 are described herein as being positioned at corners of liquid lens apparatus 100, other embodiments are included in this disclosure. For example, in some embodiments, one or more of the cutouts 136 can be disposed inboard of the outer perimeter of liquid lens apparatus 100 and/or along one or more edges of liquid lens apparatus 100.

In some embodiments, driving electrode 126 can include a plurality of driving electrode segments. For example, as shown in FIG. 2, driving electrode 126 can include a first driving electrode segment 126A, a second driving electrode segment 126B, a third driving electrode segment 126C, and a fourth driving electrode segment 126D. In some embodiments, the driving electrode segments 126A-126D can be distributed substantially uniformly about sidewall 140 of cavity 104. For example, each driving electrode segment can occupy about one quarter, or one quadrant, of sidewall 140 of cavity 104. In some embodiments, adjacent driving electrode segments 126A-126D are isolated from each other by a scribe. For example, first driving electrode segment 126A and second driving electrode segment 126B can be isolated from each other by scribe 130B. Additionally, or alternatively, second driving electrode segment 126B and third driving electrode segment 126C are isolated from each other by a scribe 130C. Additionally, or alternatively, third driving electrode segment 126C and fourth driving electrode segment 126D are isolated from each other by a scribe 130D. Additionally, or alternatively, fourth driving electrode segment 126D and first driving electrode segment 126A are isolated from each other by a scribe 130E. The various scribes 130 can be configured as described herein in reference to scribe 130A. In some embodiments, the scribes between the various electrode segments extend beyond cavity 104 and onto the back side of liquid lens apparatus 100 (not shown). Such a configuration can ensure electrical isolation of the adjacent driving electrode segments 126A-126D from each other. Additionally, or alternatively, such a configuration can enable each driving electrode segment 126A-126D to have a corresponding contact for electrical connection as described herein.

Although driving electrode 126 is described herein as being divided into four driving electrode segments 126A-126D, other embodiments are included in this disclosure. In some other embodiments, driving electrode 126 can include a single driving electrode (e.g., substantially circumscribing sidewall 140 of cavity 104). For example, the liquid lens comprising such a single driving electrode can be capable of varying focal length, but incapable of tilting the interface (e.g., an autofocus only liquid lens). In some other embodiments, the driving electrode 126 can be divided into two, three, five, six, seven, eight, or more driving electrode segments (e.g., distributed substantially uniformly about sidewall 140 of cavity 104).

In some embodiments, bond 134B and/or bond 134C can be configured such that electrical continuity is maintained between the portion of conductive layer 128 inside the respective bond and the portion of the conductive layer outside the respective bond. In some embodiments, liquid lens apparatus 100 can include one or more cutouts 136 in second outer layer 122. For example, liquid lens apparatus 100 can include similar cutouts 136A-136D, shown in FIG. 2 in first outer layer 118, in second outer layer 122. In some embodiments, cutouts 136 can include portions of liquid lens apparatus 100 at which second outer layer 122 is removed to expose conductive layer 128. Thus, cutouts 136 can enable electrical connection to driving electrode 126, and the regions of conductive layer 128 exposed at cutouts 136 can serve as contacts to enable electrical connection of liquid lens apparatus 100 to a controller, a processor, a driver, or another component of a lens or camera system.

Different driving voltages can be supplied to different driving electrode segments to tilt the interface of liquid lens apparatus 100 (e.g., for OIS functionality). For example, tilting interface 110 can cause an angle to be formed between the optical axis of liquid lens apparatus 100 (e.g., the optical axis of interface 110) and structural axis 112 of liquid lens apparatus 100. In some embodiments, such an angle can be referred to as a mechanical tilt angle, and an optical tilt angle of liquid lens apparatus 100 can be determined by multiplying the mechanical tilt angle by the refractive index difference Δn between first liquid 106 and second liquid 108. Additionally, or alternatively, a driving voltage can be supplied to a single driving electrode or the same driving voltage can be supplied to each driving electrode segment to maintain interface 110 of liquid lens apparatus 100 in a substantially spherical orientation about structural axis 112 (e.g., for autofocus functionality) and/or to maintain the optical axis in alignment with structural axis 112.

In some embodiments, first outer layer 118 can include a peripheral portion 118A, a central portion 118B, an exterior side 118C, and an interior side 118D, as shown in FIG. 1. For example, peripheral portion 118A can be disposed laterally outboard (or farther from structural axis 112) of central portion 118B. In some embodiments, central portion 118B can include first window 114. For example, central portion 118B can at least partially overlie cavity 104, whereby at least a portion of central portion 118B of first outer layer 118 can serve as first window 114. In some embodiments, peripheral portion 118A of first outer layer 118 can be bonded to intermediate layer 120 (e.g., at bond 134A) as described herein. In some embodiments, first outer layer 118 can include a monolithic or unitary body (e.g., formed from a single piece of material such as, for example, a glass substrate). For example, each of peripheral portion 118A and central portion 118B can be part of the monolithic first outer layer 118.

In some embodiments, first outer layer 118 can include a thinned region or membrane. For example, the thinned region can have a lower stiffness than peripheral portion 118A and/or central portion 118B of first outer layer 118, which can enable first window 114 to move or expand (e.g., translate axially) as described herein. In some embodiments, the thinned region can comprise an annular thinned region, which can at least partially circumscribe first window 114 and/or cavity 104. In some embodiments, central portion 118B can include a thinned region or membrane. For example, the thinned region can be in communication with the bore in intermediate layer 120, as shown in FIG. 1, such that the bore and the thinned region cooperatively define cavity 104.

In some embodiments, central portion 118B of first outer layer 118 enables first window 114 to translate relative to peripheral portion 118A in the axial direction. For example, first outer layer 118 can flex or bend at central portion 118B which can be caused by, for example, expansion or contraction of first liquid 106 and/or second liquid 108 within cavity 104 (e.g., as a result of an increase or decrease in temperature and/or pressure), by physical shock to first outer layer 118, or by another force exerted on first outer layer 118 (e.g., from inside or outside cavity 104) to balance a mechanical deflection of first outer layer 118 and an internal pressure of first liquid 106 and/or second liquid 108 within cavity 104. Such flexing or bowing of central portion 118B and first window 114 can cause a change in optical power (e.g., focal length or focus) of liquid lens apparatus 100 resulting from a change in curvature of first window 114.

In some embodiments, a thickness of peripheral portion 118A of first outer layer 118 is substantially the same as a thickness of central portion 118B and/or first window 114. Additionally, or alternatively, a substantially uniform thickness of peripheral portion 118A and central portion 118B and/or first window 114, can enable first outer layer 118 to be formed from a substantially planar sheet of material without thinning the central portion 118B and/or the first window 114 (e.g., without etching, grinding, or polishing the central portion and/or the first window to reduce the thickness thereof). Avoiding such a thinning step can help to maintain the surface quality of first window 114, which can improve the image quality of liquid lens apparatus 100 compared to liquid lenses with thinned window regions. Additionally, or alternatively, avoiding such a thinning step can reduce the number of steps involved in manufacturing first outer layer 118 compared to liquid lenses with thinned window regions, thereby simplifying production of liquid lens apparatus 100. In some embodiments, a thickness of first outer layer 118 can be about 25μm to about 250μm. For example, central portion 118B and/or first window 114 can have a thickness of about 25μm to about 50μm.

In some embodiments, cavity 104 can include a sidewall 140 extending between first outer layer 118 and second window 116. For example, sidewall 140 can be defined by the bore in intermediate layer 120 (e.g., a wall of the bore) and/or conductive layer 128 (e.g., a portion of the conductive layer disposed on a portion of the wall of the bore). In some embodiments, sidewall 140 can be straight (e.g., along the sidewall of cavity 104 in the axial direction). For example, the deviation of sidewall 140 from linear, measured along an entire height of the sidewall in the axial direction, is at most about 50μm, at most about 40μm, at most about 30μm, at most about 20μm, at most about 10μm, at most about 5μm, or any ranges defined by the listed values.

Although liquid lens apparatus 100 is described herein as comprising an electrowetting-based liquid lens, other embodiments are included in this disclosure. In some embodiments, the liquid lens apparatus comprises a variable focus lens, which can be a liquid lens (e.g., an electrowetting-based liquid lens as described in reference to liquid lens 100), a hydrostatic fluid lens (e.g., comprising a fluid or polymeric material disposed within a flexible membrane with a curvature that is variable, for example, by injecting or withdrawing fluid and/or by applying an external force to the fluid lens), a liquid crystal lens, or another type of lens having a focal length that can be changed (e.g., without translating, tilting, or otherwise moving the lens assembly relative to the image sensor). A strain gauge as described herein can be integrated into liquid lenses of various configurations to detect deflection of a window or membrane of the liquid lens.

Exemplary Liquid Lens Apparatus With Integrated Strain Gauge

As discussed above, in practice, as liquid lenses are subjected to varying temperatures, the liquids can expand and force windows of the liquid lens to deflect or expand. As a consequence, the optical focal length or diopter (e.g., inverse of optical focal length) of the liquid lens shifts. Further, a temperature sensor does not provide a direct measurement of the window deflection. Accordingly, there is a need for a thin-film strain sensor that can be directly integrated into a liquid lens window and provide feedback regarding the window's deflection, and a thin-film temperature sensor that can compensate for a temperature dependence of the strain sensor.

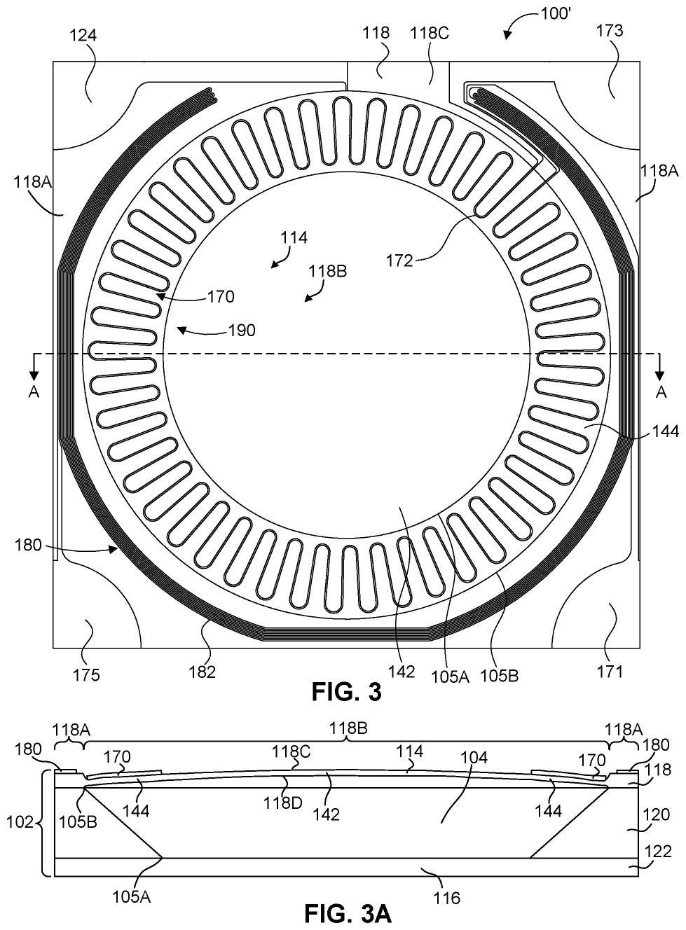

FIG. 3 illustrates a schematic top plan view of liquid lens apparatus 100′, according to exemplary embodiments. FIG. 3A illustrates a schematic cross-sectional view of liquid lens apparatus 100′ as shown in FIG. 3. The embodiments of liquid lens apparatus 100 shown in FIGS. 1 and 2 and the embodiments of liquid lens apparatus 100′ shown in FIGS. 3 and 3A are similar. Similar reference numbers are used to indicate similar features of the embodiments of liquid lens apparatus 100 shown in FIGS. 1 and 2 and the similar features of the embodiments of liquid lens apparatus 100′ shown in FIGS. 3 and 3A. The main differences between the embodiments of liquid lens apparatus 100 shown in FIGS. 1 and 2 and the embodiments of liquid lens apparatus 100′ shown in FIGS. 3 and 3A are that liquid lens apparatus 100′ includes a detector 190 (e.g., a strain gauge 170) integrated into first window 114 of first substrate 118 and configured to provide feedback regarding a deflection of first window 114 (e.g., due to a temperature change) and temperature compensator 180 integrated into peripheral portion 118A of first substrate 118 and configured to compensate for a temperature dependence of detector 190.

As shown in FIGS. 3 and 3A, liquid lens apparatus 100′ can include first substrate 118, detector 190, and temperature compensator 180. Similar to liquid lens apparatus 100 shown in FIGS. 1 and 2, first substrate 118 can include peripheral portion 118A, central portion 118B, exterior side 118C, and interior side 118D. Central portion 118B can include or coincide with first window 114. Central portion 118B and/or first window 114 can include inner section 142 and outer section 144. For example, as shown in FIG. 3, inner section 142 can include an area corresponding to an area defined by second window 116 and outer section 144 can include an annular region between inner section 142 and peripheral portion 118A. Inner and outer sections 142, 144 can be separated along narrow end 105A of cavity 104, and outer section 144 and peripheral portion 118A can be separated along wide end 105B of cavity 104. Central portion 118B and/or first window 114 can include detector 190.

Detector 190 can be configured to measure a deflection or expansion of central portion 118B and/or first window 114. For example, detector 190 can measure a deflection or expansion of central portion 118B and/or first window 114 due to a temperature change. Detector 190 can measure a strain (e.g., relative change in length) of central portion 118B and/or first window 114. In some embodiments, detector 190 can include a strain gauge (e.g., one or more resistive or piezoelectric strain gauges), any other suitable device capable of detecting a relative change in length, or some combination thereof. For example, as shown in FIG. 3, detector 190 can include strain gauge 170. Detector 190 can be an electrical conductor, while first substrate 118 can be an electrical insulator. For example, detector 190 can include strain gauge 170 such that when central portion 118B and/or first window 114 stretches (e.g., expands or bows outward away from cavity 104), a resistance of strain gauge 170 increases, and when central portion 118B and/or first window 114 compresses (e.g., collapses or bows inward toward cavity 104), a resistance of strain gauge 170 decreases.

In some embodiments, detector 190 can include strain gauge 170. As shown in

FIG. 3, strain gauge 170 can include first strain gauge contact 171, strain gauge resistor 172, and second strain gauge contact 173. Strain gauge 170 can measure a strain (e.g., relative change in length) of central portion 118B and/or first window 114. Strain gauge resistor 172 can be disposed radially along outer section 144 between peripheral portion 118A and inner section 142. For example, strain gauge resistor 172 can be a planar serpentine resistor between peripheral portion 118A and inner section 142. First and second strain gauge contacts 171, 173 can be arranged in peripheral portion 118A and provide current to strain gauge resistor 172.

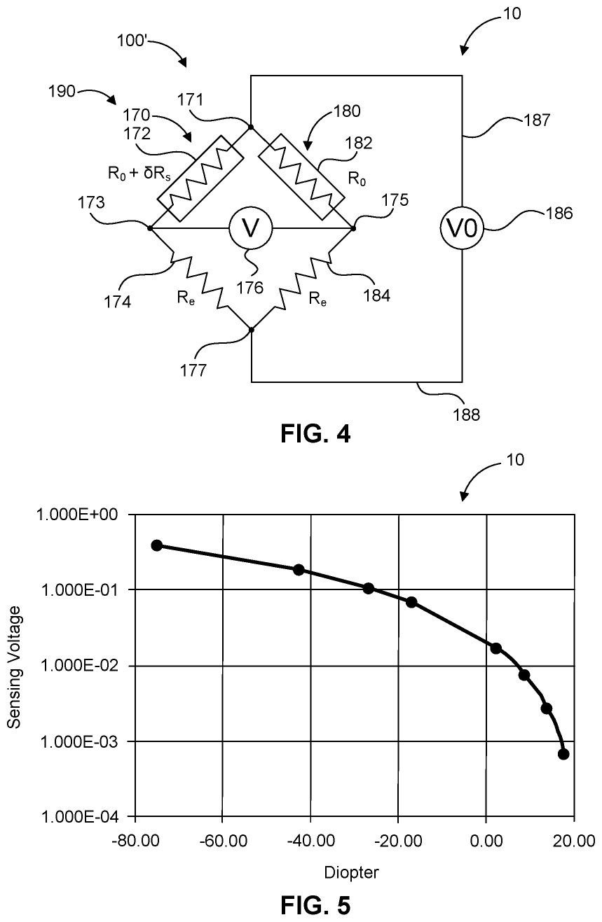

In some embodiments, strain gauge 170 can have a thickness of about 0.05μm to about 3μm. For example, strain gauge resistor 172 can have a thickness of about 0.25μm. In some embodiments, strain gauge 170 can have a width of about 1μm to about 50μm. For example, strain gauge resistor 172 can have a width of about 10μm. In some embodiments, strain gauge 170 can have a length of about 10 mm to about 150 mm. For example, strain gauge resistor 172 can have a length of about 110 mm. In some embodiments, detector 190 can be arranged in a Wheatstone bridge. For example, as shown in FIG. 4, strain gauge 170 can be arranged in a Wheatstone bridge.

Temperature compensator 180 can be configured to compensate for a temperature dependence of detector 190. For example, temperature compensator 180 can have the same or similar material, thickness, width, and/or length as detector 190 to reduce temperature dependent issues (e.g., temperature coefficient of resistance, coefficient of thermal expansion, heterogeneous materials, etc.). As shown in FIG. 3, temperature compensator 180 can include first temperature compensator contact 171 (e.g., first strain gauge contact 171), temperature compensator resistor 182, and second temperature compensator contact 175. Temperature compensator resistor 182 can be disposed in peripheral portion 118A adjacent central portion 118B and/or first window 114. In some embodiments, temperature compensator resistor 182 can be disposed azimuthally (e.g., about structural axis 112) along peripheral portion 118A adjacent outer section 144. For example, temperature compensator resistor 182 can be a planar serpentine or coil resistor disposed along peripheral portion 118A adjacent outer section 144.

In some embodiments, temperature compensator 180 can have a thickness of about 0.05μm to about 3μm. For example, temperature compensator resistor 182 can have a thickness of about 0.25μm. In some embodiments, temperature compensator 180 can have a width of about 1μm to about 50μm. For example, temperature compensator resistor 182 can have a width of about 10μm. In some embodiments, temperature compensator 180 can have a length of about 10 mm to about 150 mm. For example, temperature compensator resistor 182 can have a length of about 110 mm. In some embodiments, temperature compensator 180 can have the same thickness, width, and/or length as detector 190. In some embodiments, temperature compensator 180 can have the same temperature sensitivity as detector 190. In some embodiments, temperature compensator resistor 182 can surround a majority of detector 190. In some embodiments, as shown in FIG. 4, temperature compensator 180 can be arranged in a Wheatstone bridge.

In some embodiments, detector 190 and temperature compensator 180 can include a similar material. For example, detector 190 and temperature compensator 180 can include a metal, doped polysilicon, a semiconductor, a piezoelectric, or any combination thereof. In some embodiments, as shown in FIG. 3, central portion 118B can be first window 114, outer section 144 can be an exterior surface of first window 114 (e.g., exterior side 118C), and detector 190 can be disposed on outer section 144. For example, strain gauge 170 can be disposed on exterior side 118C of outer section 144. In some embodiments, central portion 118B can be first window 114, outer section 144 can be an interior surface of first window 114 (e.g., interior side 118D), and detector 190 can be disposed on outer section 144. For example, strain gauge 170 can be disposed on interior side 118D of outer section 144. In some embodiments, liquid lens apparatus 100′ can include an applied voltage 186. For example, as shown in FIG. 4, applied voltage 186 can be applied to detector 190 and temperature compensator 180 in a Wheatstone bridge. In some embodiments, applied voltage 186 can be a common electrode. For example, applied voltage 186 can be common electrode 124, which can be connected to first liquid 106.

Exemplary Liquid Lens System With Wheatstone Bridge

FIG. 4 illustrates a schematic circuit diagram of liquid lens system 10, according to exemplary embodiments. In some embodiments, liquid lens system 10 can include a window strain gauge sensor. Liquid lens system 10 can be configured to directly measure a deflection of first window 114 of liquid lens apparatus 100′ (e.g., due to a temperature change in liquid lens apparatus 100′). Liquid lens system 10 can include liquid lens apparatus 100′, first balancing resistor 174, second balancing resistor 184, and applied voltage 186 arranged in a Wheatstone bridge. A Wheatstone bridge is an electrical circuit used to measure electrical resistance by balancing a first branch and a second branch of a bridge circuit. The first branch (e.g., measuring branch) of the Wheatstone bridge includes strain gauge 170 and first balancing resistor 174. First balancing resistor 174 is between second strain gauge contact 173 and balancing resistor contact 177. The second branch (e.g., nulling branch) of the Wheatstone bridge includes temperature compensator 180 and second balancing resistor 184. Second balancing resistor 184 is between second temperature compensator contact 175 and balancing resistor contact 177. As shown in FIG. 4, applied voltage 186 can be connected along first voltage line 187 to first strain gauge contact 171, which is also first temperature compensator contact 171, and along second voltage line 188 to balancing resistor contact 177. Sensing voltage 176 (e.g., a galvanometer) can be measured between second strain gauge contact 173 and second temperature compensator contact 175 and detect resistance changes in strain gauge 170. When the first and second branches are balanced, no current flows between second strain gauge contact 173 and second temperature compensator contact 175 and sensing voltage 176 is zero.

Sensing voltage 176 between strain gauge 170 and temperature compensator 180 of the Wheatstone bridge can be expressed as

$$V = {V}_{0} ( \frac{{R}_{e} δ {R}_{s}}{{R}_{0}^{2} + {R}_{e}^{2} + 2 {R}_{0} {R}_{e} + δ {R}_{s} ( {R}_{0} + {R}_{e} )} ) ,$$

where V₀ is applied voltage 186 to the Wheatstone bridge, Rₑ is a resistance of the first and second balancing resistors 174, 184, R₀ is an unstrained resistance of strain gauge 170 and temperature compensator 180, and δRₛ is a change in resistance with strain of strain gauge 170. In some embodiments, first and second balancing resistors 174, 184 can have the same resistance. In some embodiments, strain gauge resistor 172 and temperature compensator resistor 182 can have the same unstrained resistance. In some embodiments, first and second balancing resistors 174, 184 can be precision off-board resistors, external to liquid lens apparatus 100′. For example, first and second balancing resistors 174, 184 can each have a resistance of about 500 Ω to about 5 kΩ.

In some embodiments, liquid lens system 10 can measure a diopter shift in liquid lens apparatus 100′ due to a temperature change. In some embodiments, liquid lens system 10 can calibrate first and second balancing resistors 174, 184 in the Wheatstone bridge based on unstrained resistance values of strain gauge 170 and temperature compensator 180. In some embodiments, liquid lens system 10 can measure a diopter shift in liquid lens apparatus 100′ based on strained resistance values of strain gauge 170 and temperature compensator 180 due to a temperature change and an expansion of first window 114. In some embodiments, liquid lens system 10 can measure a diopter shift in liquid lens apparatus 100′ due to a temperature change in real time. For example, liquid lens system 10 can measure a sensing voltage 176 in at least 0.2 sec. In some embodiments, liquid lens system 10 can achieve a diopter shift sensitivity in liquid lens apparatus 100′ due to a temperature change of at least 0.4 diopter.

FIG. 5 illustrates a schematic plot of a diopter shift of liquid lens system 10 of

FIG. 4, according to exemplary embodiments. In some embodiments, liquid lens system 10 can include a strain gauge circuit. The plot shows sensing voltage 176 versus diopter shift in liquid lens apparatus 100′ based on a change of radial strain (e.g., δRₛ) of first window 114, as shown below in Table 1.

| | Radius of | | Radial Strain | Sensing Voltage | |
|---|---|---|---|---|---|
| Regime | Curvature (mm) | Strain | (δRₛ) | (V) | Diopter |
| Flat | 1.00E+20 | 0.00000E+00 | 0.00000E+00 | 0.00000E+00 | 21.60 |
| Operating | 1000 | 1.36533E−06 | 4.01955E−03 | 6.82666E−06 | 21.21 |
| | 100 | 1.36549E−04 | 4.02000E−01 | 6.82559E−04 | 17.74 |
| | 50 | 5.46385E−04 | 1.60856E+00 | 2.72894E−03 | 13.88 |
| Extreme | 30 | 1.51898E−03 | 4.47188E+00 | 7.57191E−03 | 8.73 |
| | 20 | 3.42320E−03 | 1.00779E+01 | 1.69996E−02 | 2.29 |
| | 10 | 1.38131E−02 | 4.06656E+01 | 6.72086E−02 | −17.01 |
| | 8 | 2.17267E−02 | 6.39635E+01 | 1.04110E−01 | −26.67 |
| | 6 | 3.91936E−02 | 1.15386E+02 | 1.81723E−01 | −42.76 |
| | 4 | 9.21348E−02 | 2.71245E+02 | 3.88994E−01 | −74.93 |

Table 1 values are based on strain gauge resistor 172 having a thickness of 0.25μm and a width of 10μm, applied voltage (V₀) 186 being 5 V, resistance (Rₑ) of first and second balancing resistors 174, 184 being 736Ω, and unstrained resistance (R₀) of strain gauge 170 and temperature compensator 180 being 736Ω(e.g., R₀=Rₑ), and interface 110 of liquid lens apparatus 100′ having a negative 5 mm meniscus. As shown in FIG. 5, a diopter shift of 7.72 diopter can occur in an operating range of liquid lens apparatus 100′ due to strain. A measured sensing voltage 176 of 6.823μV can correspond to a diopter shift of 0.39 diopter. Liquid lens system 10 can achieve a diopter shift voltage sensitivity of at least 0.057 diopter/μV.

In some embodiments, in a first step, first and second balancing resistors 174, 184 of the Wheatstone bridge of liquid lens system 10 can be calibrated based on unstrained resistance values of strain gauge 170 and temperature compensator 180 of liquid lens apparatus 100′. In some embodiments, in a second step, a diopter shift of liquid lens apparatus 100′ can be measured by the Wheatstone bridge of liquid lens system 10 based on strained resistance values of strain gauge 170 and temperature compensator 180 (e.g., due to a temperature change and an expansion of first window 114). For example, the diopter shift of liquid lens apparatus 100′ can be measured in real time. For example, the diopter shift of liquid lens apparatus 100′ can be measured with a sensitivity of at least 0.4 diopter.

Alternative Liquid Lens Apparatus With Integrated Strain Gauge

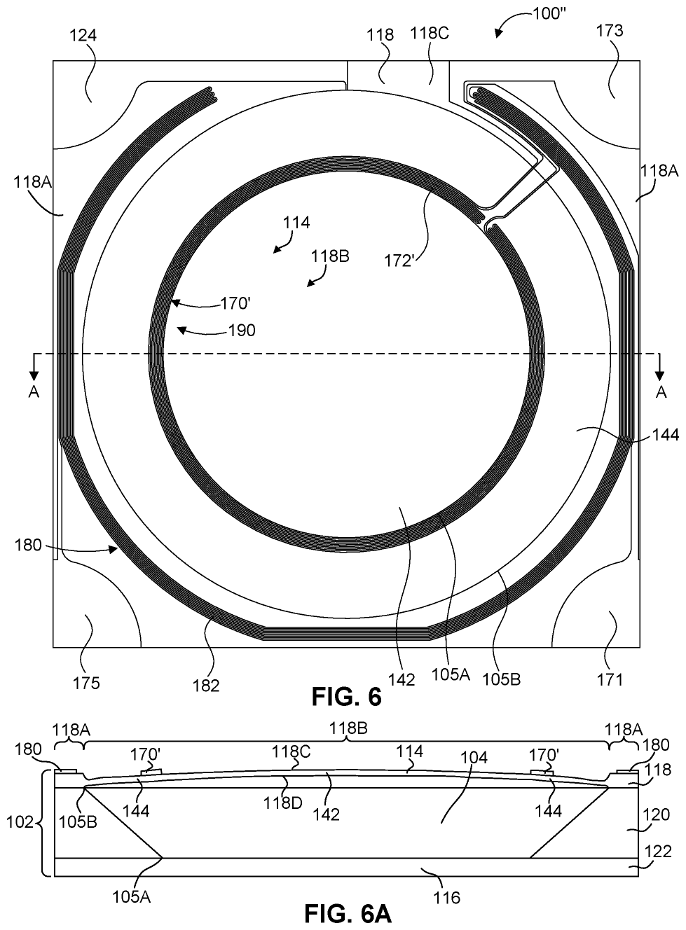

FIG. 6 illustrates a schematic top plan view of liquid lens apparatus 100″, according to exemplary embodiments. FIG. 6A illustrates a schematic cross-sectional view of liquid lens apparatus 100″ as shown in FIG. 6A. The embodiments of liquid lens apparatus 100′ shown in FIGS. 3-5 and the embodiments of liquid lens apparatus 100″ shown in FIGS. 6 and 6A are similar. Similar reference numbers are used to indicate similar features of the embodiments of liquid lens apparatus 100′ shown in FIGS. 3-5 and the similar features of the embodiments of liquid lens apparatus 100″ shown in FIGS. 6 and 6A. The main difference between the embodiments of liquid lens apparatus 100′ shown in FIGS. 3-5 and the embodiments of liquid lens apparatus 100″ shown in FIGS. 6 and 6A is that liquid lens apparatus 100″ includes strain gauge 170′ which includes an azimuthally (e.g., about structural axis 112) arranged strain gauge resistor 172′ integrated into first window 114 of first substrate 118 rather than radially arranged strain gauge resistor 172 of strain gauge 170 as shown in FIG. 3. As shown in FIG. 6, strain gauge resistor 172′ can be disposed azimuthally or circumferentially (e.g., about structural axis 112) between inner section 142 and outer section 144. For example, strain gauge resistor 172′ can be a planar serpentine or coil resistor between peripheral portion 118A and inner section 142.

It is to be understood that the phraseology or terminology herein is for the purpose of description and not of limitation, such that the terminology or phraseology of the present specification is to be interpreted by those skilled in relevant art(s) in light of the teachings herein.

The term “substrate” as used herein describes a material onto which material layers can be added. In some embodiments, the substrate itself may be patterned and materials added on top of it may also be patterned, or may remain without patterning.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals, and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, and/or instructions.

The examples described herein are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

While specific embodiments of the disclosure have been described above, it will be appreciated that the disclosure may be practiced otherwise than as described. The description is not intended to be limiting, but rather exemplary.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein.

The breadth and scope of the present disclosure should not be limited by any of the above-described exemplary embodiments, but should be defined only in accordance with the following claims and their equivalents.

What is claimed is:

1. A liquid lens apparatus comprising:
a substrate comprising central and peripheral portions and a detector to measure a deflection of the central portion; and
a temperature compensator disposed in the peripheral portion to compensate for a temperature dependence of the detector.

2. The liquid lens apparatus of claim 1, wherein:
the central portion of the substrate comprises first and second sections; and
the detector comprises a resistor disposed radially along the first section between the peripheral portion and the second section.

3. The liquid lens apparatus of claim 1, wherein:
the central portion of the substrate comprises first and second sections; and
the detector comprises a resistor disposed azimuthally between the first and second sections.

4. The liquid lens apparatus of claim 1, wherein the temperature compensator comprises a resistor disposed azimuthally along the peripheral portion.

5. The liquid lens apparatus of claim 1, wherein the detector is a strain gauge.

6. The liquid lens apparatus of claim 5, wherein the strain gauge and the temperature compensator comprise doped polysilicon.

7. The liquid lens apparatus of claim 1, wherein the detector and the temperature compensator comprise substantially a same thickness, width, and length.

8. The liquid lens apparatus of claim 1, wherein:
the central portion comprises a window;
the central portion of the substrate comprises first and second sections on an exterior side of the window; and
the detector is disposed on the first section.

9. The liquid lens apparatus of claim 1, wherein:
the central portion comprises a window;
the central portion of the substrate comprises first and second sections on an interior side of the window; and
the detector is disposed on the first section.

10. The liquid lens apparatus of claim 1, wherein the temperature compensator surrounds a majority of the detector.

11. A liquid lens system comprising:
a liquid lens apparatus comprising:
a substrate comprising a window, a peripheral portion, a strain gauge, and a temperature compensator, wherein:
the strain gauge is configured to measure a deflection of the window; and
the temperature compensator is configured to compensate for a temperature dependence of the strain gauge;
a first balancing resistor coupled to the strain gauge; and
a second balancing resistor coupled to the temperature compensator,
wherein the strain gauge, the temperature compensator, and the first and second balancing resistors form a Wheatstone bridge.

12. The liquid lens system of claim 11, wherein the Wheatstone bridge is configured to directly measure a deflection of the window.

13. The liquid lens system of claim 11, wherein the first and second balancing resistors comprise substantially a same resistance.

14. The liquid lens system of claim 11, wherein a sensing voltage between the strain gauge and the temperature compensator of the Wheatstone bridge is:
$$V = {V}_{0} ( \frac{{R}_{e} δ {R}_{s}}{{R}_{0}^{2} + {R}_{e}^{2} + 2 {R}_{0} {R}_{e} + δ {R}_{s} ( {R}_{0} + {R}_{e} )} )$$
wherein V₀ is an applied voltage to the Wheatstone bridge, Rₑ is a resistance of the first and second balancing resistors, R₀ is an unstrained value of the strain gauge and the temperature compensator, and δRₛ is a change in resistance with strain of the strain gauge.

15. The liquid lens system of claim 11, wherein the strain gauge comprises a planar serpentine resistor disposed between the peripheral portion and an inner section of the window.

16. The liquid lens system of claim 11, wherein the strain gauge comprises a planar coil resistor disposed along an outer section of the window adjacent an inner section of the window.

17. The liquid lens system of claim 11, wherein the temperature compensator comprises a planar coil resistor disposed along the peripheral portion adjacent an outer section of the window.

18. A method for measuring a diopter shift in a liquid lens apparatus, the method comprising:
calibrating first and second balancing resistors in a Wheatstone bridge based on unstrained resistance values of a strain gauge and a temperature compensator of the liquid lens apparatus; and
measuring a diopter shift of the liquid lens apparatus based on strained resistance values of the strain gauge and the temperature compensator and an expansion of a window of the liquid lens apparatus.

19. The method of claim 18, wherein the measuring occurs in real time.

20. The method of claim 18, wherein the measuring achieves a sensitivity of at least 0.4 diopter.
